(19) United States
(12) Patent Application Publication
(10) Pub. No.: US 2025/0156982 A1
(43) Pub. Date: May 15, 2025

(54) DYNAMIC FIRE SUPPRESSION SYSTEM CONFIGURATOR

(71) Applicant: Tyco Fire Products LP, Cranston, RI (US)

(72) Inventors: Mayank Sharma, Philadelphia, PA (US); Denise Therese Arruda, Hope Valley, RI (US); Suzanne Lynn Gregory DalBon, Lincoln, RI (US); Christopher Michael Blasko, Allentown, PA (US); Ovidiu Butoi, Ringoes, NJ (US); Robert Edwyn Smith, Sellersville, PA (US); Anil Kumar Yadav, Bangalore (IN); Kristin M. Ryczek, Oconto Falls, WI (US); Kathleen M. Lomi, Coventry, RI (US)

(73) Assignee: Tyco Fire Products LP, Cranston, RI (US)

(21) Appl. No.: 18/940,167

(22) Filed: Nov. 7, 2024

(30) Foreign Application Priority Data
Nov. 9, 2023 (IN) 202341076540

(51) Int. Cl. G06Q 50/26; G06Q 10/0631

(52) U.S. Cl. CPC G06Q 50/265; G06Q 10/06313

(57) ABSTRACT

A configurator to configure a fire suppression system is provided. The configurator includes a data processing system comprising one or more processors, coupled with memory, to receive, from a first source, common data for a project; receive, from a second source different than the first source, product data comprising product specifications for a plurality of fire suppression products; and generate, based on the common data and the product data, a plurality of system pairings for the project, each system pairing including a list of fire suppression components for the project. The second source can be a rules engine to dynamically update the configurator.

### CROSS-REFERENCE TO RELATED APPLICATIONS

The present application claims the benefit of and priority to Indian Provisional Patent Application No. 202341076540, filed Nov. 9, 2023, the disclosure of which is incorporated herein by reference in its entirety.

### BACKGROUND

Fire suppression systems can use a number of different fire suppression agents, activators, and distribution methods, and selecting the appropriate configuration can depend on a number of factors. Due to the increasingly large number of possible configurations, it can be challenging to reliably and quickly design a fire suppression system that is appropriate for a given space and yet takes into account the various configuration possibilities.

### SUMMARY

At least one aspect of the present disclosure is directed to a system of dynamic fire suppression system configurator. The system can include a data processing system to receive, from a first source, common data for a project. The system can receive, from a second source different than the first source, product data comprising product specifications for a plurality of fire suppression products. The system can generate, based on the common data and the product data, a plurality of system pairings for the project, each system pairing comprising a list of fire suppression components for the project.

At least one aspect of the present disclosure is directed to a method of dynamic fire suppression system configurator. The method can be performed by a data processing system comprising one or more processors coupled with memory. The method can include the data processing system receiving, by a data processing system, common data for a project from a first source. The method can include the data processing system receiving product data comprising product specifications for a plurality of fire suppression products from a second source different than the first source. The method can include generating, based on the common data and the product data, a plurality of system pairings for the project, each system pairing comprising a list of fire suppression components for the project based on the common data and a unique system configuration.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system of a dynamic fire suppression system configurator.

FIG. 2 depicts an example operation of a dynamic fire suppression system configurator.

FIGS. 3-14 depict example graphical user interfaces provided by a dynamic fire suppression system configurator.

FIG. 15 is a block diagram illustrating an architecture for a computer system that can be employed to implement elements of the systems and methods described and illustrated herein, including aspects of the systems depicted in FIG. 1 and the graphical user interfaces depicted in FIGS. 3-14, and the processes or methods depicted in FIG. 2.

### DETAILED DESCRIPTION

Following below are more detailed descriptions of various concepts related to, and implementations of, methods, apparatus, and systems of dynamic fire suppression system configurator. The various concepts introduced above and discussed in greater detail below may be implemented in any of numerous ways.

This disclosure is directed to systems, methods, and apparatus for a dynamic fire suppression system configurator. For example, due to the rapid increase in the number and complexity of fire suppression system types, the design and configuration (as well as pricing and quoting) of a fire suppression system for a project such as a building has become more difficult and resource intensive. Further, deterministic design of fire suppression systems may not be tractable, as the solution space for selecting parameters for a design for the fire suppression system can have a large number of interdependent variables (e.g., locations from which components are to be sourced, location at which the fire suppression system is to be installed, location-based criteria for component performance, number of components, relationships between components (e.g., fluid flow, distance, boundaries of structures in a building), uncertainties with respect to expected or actual performance of components, timing requirements for criteria of delivery and/or install of components such that improper sequencing can result in excess transportation and/or storage resources, or various combinations thereof). Therefore, manual methods for system design can fail to achieve sufficient accuracy to ensure proper selection and delivery of system components, and various computational methods such as complex simulations can be highly compute-intensive.

Systems and methods in accordance with the present disclosure relate to a dynamic fire suppression system configurator that can allow for more effective system configuration and/or selection of fire suppression system components, such as to achieve performance criteria with respect to accuracy and avoid excessive compute resource usage. There are various types of fire suppression systems, each with their own benefits. A fire suppression system can include various tanks configured to store and discharge a fire suppression agent, a piping system configured to fluidly couple the tanks of fire suppression agent with dispersion devices to discharge the fire suppression agent to an area of interest, and various activators and sensors configured to detect a hazard such as a fire and activate the fire suppression system to discharge the fire suppression agent to the hazard. Different fire suppression system types can use different components (e.g., tanks, distribution systems, dispersion devices, activators, sensors, and other fire suppression system components), agents, and different arrangements of components. For example, a first type of fire suppression system can use a liquid fire suppression agent, and a second type of fire suppression can use an inert gas fire suppression agent. However, because different types of fire suppression system can use different components, agents, or layouts, designing and comparing different fire suppression systems types to each other for the same given space can be time and resource intensive, and require redundant data processing and storage for characteristics of the space and project details that do not change from system to system and yet are necessary for configuring and designing each system type.

Systems and methods in accordance with the present disclosure can include a dynamic fire suppression configurator to design and compare multiple fire suppression system types within a single project and for a single space. To do so, the dynamic fire suppression configurator can receive, process, and maintain a single data set containing details of the project and space to be protected. Thereafter, when the dynamic fire suppression configurator is used to design different fire suppression systems of different system types, the dynamic fire suppression configurator can refer to the single data for common information about the project and space relevant to different system types. The dynamic fire suppression configurator can therefore reduce redundancies in data processing and storage and reduce the amount of power and energy required from designing and configuring the different system types separately.

To reduce the time and resources required to select a single fire suppression system design from the range of possible fire suppression system designs, including of different system types, this technical solution can provide for streamlined and normalized data collection and use. Common data, data that is relevant to for multiple different fire suppression system designs (e.g., project details, building enclosures, distribution piping arrangements, actuation groups, and other common data) can be captured. This technical solution can maintain the common data in a single data set and use the common data for configuring multiple possible fire suppression system designs for the same project. This technical solution thereby reduces the redundancies in data processing and storage required when different potential fire suppression system designs for the same project are configured and designed, which would otherwise require the duplicate input and storage of the common data already used to configure a different fire suppression system design. Merging the configuration process for multiple potential fire suppression system designs and using a common data source can reduce these redundancies.

To facilitate these benefits, the technology can dynamically respond to the common data. This technology can be configured for or otherwise integrated with a business rules engine, allowing the dynamic fire suppression system configurator to dynamically request and receive data based on previously provided data according to the rules and data sets in the business rules engine. The data sets in the business rules engine or provided to it can include product specifications for multiple different fire suppression products. The fire suppression products can be groupings of inter-operable fire suppression system components, for example product families provided by a manufacturer and certified or otherwise indicated as inter-operable. The product specifications can include data for multiple different fire suppression products. The rules in the business rules engine can be logical expressions or statements whose terms can be based on the data provided to the rules (e.g., the common data and other relevant data) or data made available to the rules (e.g., the product specifications) and whose output can be one or more parameters of a fire suppression system (e.g., a fire suppression system type, a component type, a component, a component quantity, a dimension, a location, and other parameters of a fire suppression system). One or more of the common data, product data, and the output of the business rules engine can be used to create a possible design of a fire suppression system for a space. The technology can generate multiple system pairings (e.g., possible fire suppression system designs) for a single project based on the common data and the business rules engine output. Each system pairing can be a unique pairing of a project space with a fire suppression system type, where the same project space can be used in multiple different system pairings with multiple different fire suppression system types. Multiple potential designs can be provided by altering the data provided to the rules. For example, a first design can be based on a first system pairing of a project space with a first fire suppression product, and a second design can be based on a second system pairing of the same project space with a second fire suppression product.

The state of the project can be monitored and assigned a confidence value indicating the probability of the project or a stage of the product succeeding. The project and any generated system pairings, or a selected preferred (e.g., target) system pairing, can be integrated with or provided to a supplier. The technology can provide the supplier with a bill of materials (BOM) for the system pairings. The technology can allow suppliers to preview proposed fire suppression system designs and BOMs at an earlier stage of the configuration process, allowing improved demand planning. For example, a supplier can determine that 80% of pending potential system pairings require a specific fire suppression component and can order or otherwise initiate obtaining the component in advance of actual orders.

This technical solution can provide various improvements, efficiencies, or new functionalities, including, for example, the ability to update the business rules engine rules or product specifications to dynamically adjust the output of the business rules engine. By separating the business rules engine from the dynamic fire suppression system configurator, this technical solution can allow the dynamic fire suppression system configurator to generate fire suppression system pairings (e.g., potential or possible fire suppression system designs) based on new or updated product specifications or rules added to the business rules engine without needing to change to the dynamic fire suppression system configurator itself.

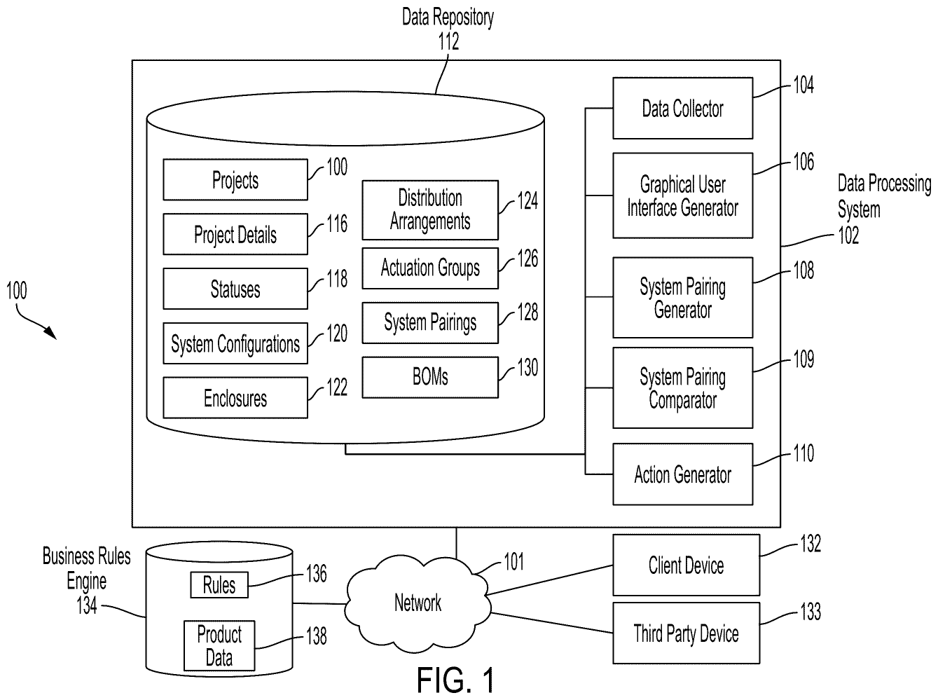

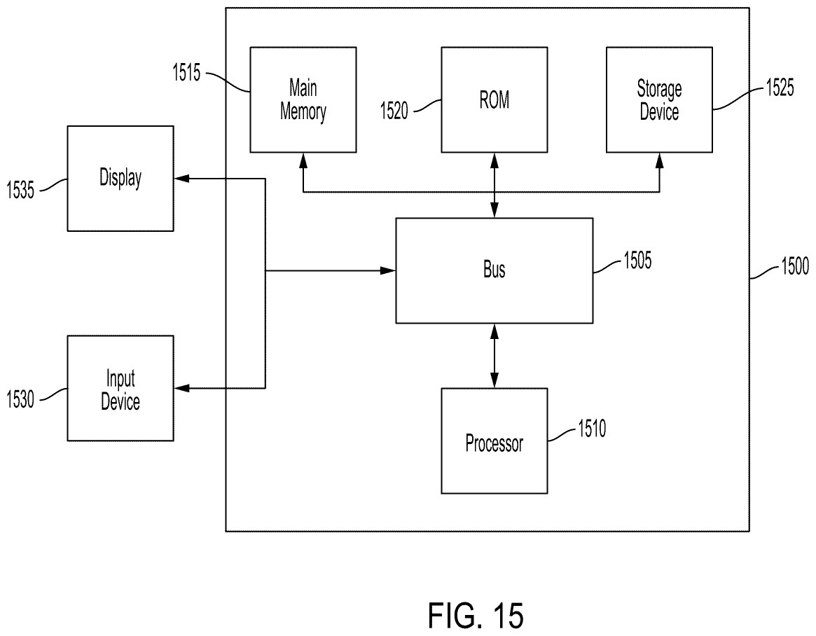

FIG. 1 depicts an example system 100 of dynamic fire suppression system configurator. The system 100 can include a data processing system 102. The data processing system can include one or more component or functionality depicted in FIG. 15. The data processing system 102 can include a data collector 104 to receive, fetch, request, scrub, scrape, or otherwise obtain data from one or more data sources. The data processing system 102 can include a graphical user interface generator 106 to generate, update, display, and otherwise provide a graphical interface for a user to interact with the fire suppression system configurator 100. The data processing system 102 can include a system pairing comparator 106 to compare one or more parameters (e.g., cost, floor space occupied, estimated installation time, lifespan, capability, or other parameter) of a plurality of system pairings to determine a target system pairing. The data collector 104 can receive a target system pairing from a user selection of a system pairing from the plurality of system pairings. The system pairing comparator 106 can determine the target system pairing based on one or more rules, thresholds, or other data provided to the data processing system 102. bill of materials for a plurality of system pairings. The data processing system 102 can include an action generator 110 to perform an action using a function in response to a request or query from a client device 134.

The data collector 104, graphical user interface generator 106, system pairing generator 108, system pairing comparator 109, and action generator 110 can each communicate with the data repository 112 or database. The data processing system 102 can include or otherwise access the data repository 112. The data repository 112 can include one or more data files, data structures, arrays, values, or other information that facilitates operation of the data processing system 102. The data repository 112 can include one or more local or distributed databases and can include a database management system.

The data repository 112 can include projects 114. The projects 114 can include a plurality of discrete projects. The projects 114 can be for configuring, quoting, or pricing a fire suppression one or more buildings. The data repository 112 can include project details 116. The project details can refer to or include project details for the projects 114. The project details can include a project name, a project description, a customer name associated with the project, an address, a system of measurement for the project (e.g., Imperial, metric, or another system) a fire suppression system approval authority (e.g., UL, FM, or another approval) a design standard, a transport approval authority, a thread type, one or more ship from locations, an altitude, whether a manual actuator should be present, whether a reserve is required, a bid due date, a requested delivery data, and detection and control settings for the project. The detection and control settings can include parameters for a detection and control system of a fire suppression system such as the inclusion of an auto pulse detection and control, cross-zoned detectors, an abort switch, a voltage option, a wiring type, and a panel connection. The project details 116 can include other information related to the projects 114.

The data repository 112 can include one or more statuses 118. The statuses 118 can represent a state of a project 114. For example, an allowable state of a project 114 can be as follows: Quote Requested, Quote Received, Bid/Tender Submitted, Bid/Tender Won, Bid/Tender Lost, Material ordered, Partially Delivered, and Project Complete, amongst other statuses. The statuses 118 can be associated with a confidence value. The confidence value can represent a probability of a successful outcome for a project 114 or a stage of a project 114.

The data repository 112 can include one or more system configurations 120. The system configurations 120 can refer to or include parameters of a desired fire suppression system type and other installation related settings. For example, the system configurations 120 can include a system configuration name, a description, a fire suppression agent selection, a fire suppression product selection, a vent direction, a product application, a container fabrication, a pressure gauge type, a explosion proof selection, a discharge time, a max operating temperature, a selector valve selection, a drop section selection, a manifold selection, and a discharge pressure switch selection, amongst other parameters.

The data repository 112 can include enclosures 122. The enclosures 122 can refer to or include real or virtual spaces that require protection within a project. For example, a project for a fire suppression system for a single building can include enclosures for each room in the building. The enclosures 122 can be virtual enclosures that are identified by virtual barriers instead of physical ones. The data repository 112 can include distribution arrangements 124. The distribution arrangements 124 can be one or more groups of enclosures 122. The enclosures 122 can be grouped into discrete distribution arrangements 124 for indicating the enclosures 122 use the same piping arrangement. The distribution arrangements 124 can each include a subset of the plurality of enclosures 122. Each enclosure 122 can be in one distribution arrangements 124 or multiple distribution arrangements 124. The data repository 112 can include actuation groupings 126. The actuation groupings 126 can refer to or include one or more actuation groupings 126 including a subset of the plurality of distribution arrangements 124. Each actuation group of the actuation groups 124 can include one or more of the same or different arrangements to define a common group of distribution arrangements 124, and thereby enclosures 122, for use with a common activation mechanism. Each actuation group in actuation group 126 can be a potential or possible actuation group or be alternatives to another actuation group. For example, a first actuation group 126 can include the same distribution arrangements 124 as a second actuation group 126. The different actuation groups can use different activation mechanisms or be associated with different system configurations 120.

The data repository 112 can include system pairings 128. The system pairings 128 can be based on an actuation group 126 and a product specification (e.g., system configuration 120). The plurality of system pairings 128 can include system pairings of different system configurations 120 for the same distribution group and can refer to or include one or more unique pairings of a system configuration 120 with a actuation group 126. The system pairings 128 can include references to a fire suppression product used, engineering, installation, and other information to obtain potential design of a fire suppression system for the project. The system pairings 128 can contain multiple system pairings. For example, a first actuation group 126 can be paired with a first system configuration 120 to form a first system configuration, another actuation group 126 including the same distribution arrangements 124 can be paired with a second different system configuration 120 to form a second system pairing 128. The system pairings 128 can be alternative system pairings 128 for the same space or project, allowing a user to select from a list of potential or possible system pairings 128 the target system pairing 128. The data repository 112 can include BOMs 130. The BOMs 130 can refer to or include a bill of material for each of the system pairings 128. The BOMs 130 can include a predicted or estimated cost of the system pairings 128, a quantity of components, a type of component, or other component information.

The data processing system 102 can interface with, communicate with, or otherwise receive or provide information with one or more of a client device 132 and a business rules engine 134 via a network 101. The data processing system 102, client device 132, the third party device 133, and business rules engine 134 can each include at least one logic device such as a computing device having a processor to communicate via the network 101. The data processing system 102, client device 132, the third party device 133, and business rules engine 134 can include at least one computation resource, server, processor or memory. For example, the data processing system 102 can include a plurality of computation resources or processors coupled with memory.

The network 101 can provide for communication or connectivity between the data processing system 102, client device 132, the third party device 133, and business rules engine 134. The network 101 can include computer networks such as the Internet, local, wide, metro, or other area networks, intranets, satellite networks, and other communication networks such as voice or data mobile telephone networks. The network 101 can include wired or wireless networks, connections, or communication channels. The network 101 can be used to transmit or receive information or commands to or from various components or sources. The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network, and a wireline network.

The client device 132 can refer to or include a client computing device, such as a laptop computer, desktop computer, tablet, mobile device, wearable device, or telecommunications device. The client device 132 can correspond to, host, or be included as part of a third-party platform.

The client device 132 can communicate with the data processing system 102 via network 101. The client device 132 can include one or more component or functionality depicted in FIG. 15. The client device 132 can transmit requests to the data processing system 102, receive responses from the data processing system 102, and output the responses via a display device or audio output, for example. The client device 132 can input information or otherwise control the data processing system 102.

The data processing system 102 can receive, from a first source, common data for a project. The first source can be a user or an external data source. For example, the data processing system 102 can receive the common data from a user of client device 132 via the network 101. The common data can include data of the type of the one or more of the data sources stored in the data repository 112. For example, the common data received can be one or more of the projects 114, the project details 116, the statuses 118, the system configurations 120, the enclosures 122, the distribution arrangements 124, the actuation groups 126, the system pairings 128, and the BOMs 130. The common data can be received by the data processing system 102 and stored in the data repository 112. The common data can be linked to discrete projects 114. For example, each project 114 can include its own the project details 116, the statuses 118, the system configurations 120, the enclosures 122, the distribution arrangements 124, the actuation groups 126, the system pairings 128, and the BOMs 130. The data processing system 102 can receive the common data from the data collector 104. The data collector 104 can collect, receive, or otherwise obtain the data from one or more documents or external data sources.

The data processing system 102 can receive the common data according to a graphical user interface generated by the graphical user interface generator 106. The graphical user interface generator 106 can generate a plurality of user interfaces to be provided to a user. The graphical user interfaces can request the common data from a user. For example, the graphical user interface (GUI) generator can generate a GUI to be provided to the client device 132 via the network 101.

The data processing system 102 can receive, from a second source different than the first source, product data including product specifications for a plurality of fire suppression products. The data processing system 102 can receive the product data from a second source such as the business rules engine 134. The business rules engine 134 can provide a non-programmatic depiction of business logic for determining an action based on a specific set of conditions. The business rules engine 134 can include rules 136 and data sets such as product data 138. The rules 136 can be functions or algorithms representing the business logic that operate on data (e.g., the specific set of conditions). The rules 136 can perform actions based on the evaluation of specific terms. The rules 136 can include conditions to determine whether or not the rule should be run. The rules 136 can include actions to be performed when the condition of the rules 136 are met. The rules 136 can include multiple interconnected rules that operate simultaneously or in concert to determine complex engineering solutions for a fire suppression system design without requiring a user to perform the calculation manually. The product data 138 can include product specifications for a plurality of fire suppression products. The product specifications can be regulatory requirements, component requirements, agent requirements, available components, or other product specifications associated with a particular fire suppression products. The fire suppression products can be a family of fire suppression components provided by a manufacturer, for example the Sapphire 70 bar product provided by ANSUL. The product data 138 can contain product specifications for multiple different product types provide by multiple manufacturers. The use of the rules 136 can allow the data processing system 102 to more efficiently relate input data to design selection, avoiding excess processing and/or data storage requirements.

The second source can be different than the first source. For example, the first source can be a user via the client device 132 and the second source can be the business rules engine 134. The business rules engine 134 can be managed by an entity different from the first source, for example a fire suppression systems provider. The entity managing the business rules engine 134 can therefore update the rules 136 or the product data 138 without input from the user of the client device 132. In turn, the user of the client device 132 can provide common data and interact with the business rules engine 134 without having to personally specify the rules 136 or the product data 138. The data processing system 102 can receive product data based on the common data. The rules 136 in the BRE 134 can receive the common data and determine the appropriate product data 138 to provide in response. The data processing system 102 can receive a first part of the common data and determine, based on the rules 136, a required second part of the common data is needed to continue configuring the project. The required second part of the common data can be a data field or type associated with the first part of the common data and which is required based on the first part of the common data. For example, if a dual agent fire suppression system type is selected, the data processing system 102 can determine that the dual agent selection requires a selection of the dual agents as a required second part of the common data. If a single agent system is selected, the data processing system 102 can determine that the require second part of the common data is a selection of the single agent. The first and second part of the common data can be linked or associated by one or more rules 136 of the BRE 134.

The data processing system 102 can receive, from the first source, the required second part of the common data. For example, responsive to determining what the required second part of the common data is based on the first part, the data processing system 102 can request or receive the required second part. The GUI generator 106 can generate or update a GUI presented to the user to request or receive the second part of the common data. For example, the GUI generator 106 can add a new field to be populated in the user interface based on the input in a different field of the user interface. The GUI generator 106 can add the new field dynamically and approximately in real-time. The dynamic approach allows the common data or meta-data to drive the system configuration process and relies on BRE 134 to determine what data is necessary to design the desired system. Beneficially, this aspect allows for the BRE 134 to more efficiently perform the complex calculations and reduces the need for duplicating data entries.

The data processing system 102 can generate, based on the common data and the product data, a plurality of system pairings including a list of fire suppressant components for the project. The data processing system 102 can include a system pairing generator 108 to generate the system pairings. The system pairing generator 108 can access the data repository 112 to obtain or receive the common data and the BRE 134 to obtain or receive the product data. The system pairing generator 108 can generate multiple discrete system pairings. Each system pairing can represent a unique potential and alternative fire suppression system for the project. Each system pairing can be based on one or more of the same enclosures 122, distribution arrangements 124, or actuation groups 126.

The data processing system 102 can include a system pairing comparator 109. The system pairing comparator 109 can determine, based on a comparison of at least one parameter of each of the plurality of system pairings 128, a target system pairing. The at least one parameter can include one or more of a cost, floor space occupied, estimated installation time, lifespan, capability, or other parameter, or other parameter for a fire suppression system. The system pairing comparator 109 can include one or more predefined or user-defined thresholds for evaluating and comparing the system pairings 128. The system pairing comparator 109 can provide the parameters or the comparison to a user via the client device 132 and receive the target system from the user via the client device 132. The target system pairing can be at least one of the system pairings 128. The target system pairing can be the selected potential fire suppression system design that will be used to create a bill of materials 130.

The data processing system 102 can include an action generator 110. The action generator 110 can provide an indication of the target system pairing. The indication can be an alert to a user, for example via the client device 132. For example, the indication can be an audible or visual alert to a user of the target system pairing. The indication can be a bill of materials 130 associated with the target system pairing. The indication can be provided in a user interface generated by the graphical user interface generator 106. The action generator 110 can provide the indication to a supplier of at least one fire suppression component contained in the list of fire suppression components of the target system pairing. For example, the third party device 133 can belong to a supplier and the action generator 110 can provide the indication (e.g., a bill of materials, a component order, or other indication) to the supplier via the third-party device 133. The third party device 133 can belong to a different third party. For example, the third party device 133 can be long to the same company as the client device 132. The indication can be provided to the third party device 133 to facilitate demand planning regarding the components required for the target system pairing. Some components can have a long lead time to source, and third parties can improve the time from quote to delivery and installation by anticipating orders based on the indication provided by the data processing system 102. The indication can be provided before an order is completed, allowing the third party to preview future orders.

The action generator 110 can provide the indication responsive to the confidence value being above a threshold. For example, if the confidence value is less than 80%, the action generator 110 can refrain from providing the indication. The threshold can be a predefined or user-define threshold. The threshold can be based on an amount of data or a stage of the project. For example, the threshold can be lower or higher at the beginning of a project than at the end of the project.

The data processing system 102 can generate or assign a confidence value based on at least one of the common data or the product data. The confidence value can indicate the probability of a successful outcome for the project or a stage of the project. The confidence value can be based on an organization, user, or any other level in the customer hierarchy. The confidence value can be based on the outcome of previously completed projects.

The data processing system 102 or BRE 134 can be part of or include a cloud computing environment. The data processing system 102 or BRE 134 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous-one or more of the servers or machines can operate according to one or more type of operating system platform.

The data processing system 102 can include a data collector 104 designed, configured and operational to capture data from one or more sources via network 101, or otherwise communicate with one or more of the client device 132, the third party device 133, and the BRE 134. The data collector 104 can integrate with various types of data sources. The data collector 104 can be designed, configured, constructed, or operational to receive and transmit information. The data collector 104 can receive and transmit information using one or more protocols, such as a network protocol. The data collector 104 can include a hardware interface, software interface, wired interface, or wireless interface. The data collector 104 can facilitate translating or formatting data from one format to another format. For example, the data collector 104 can include an application programming interface that includes definitions for communicating between various components, such as software components.

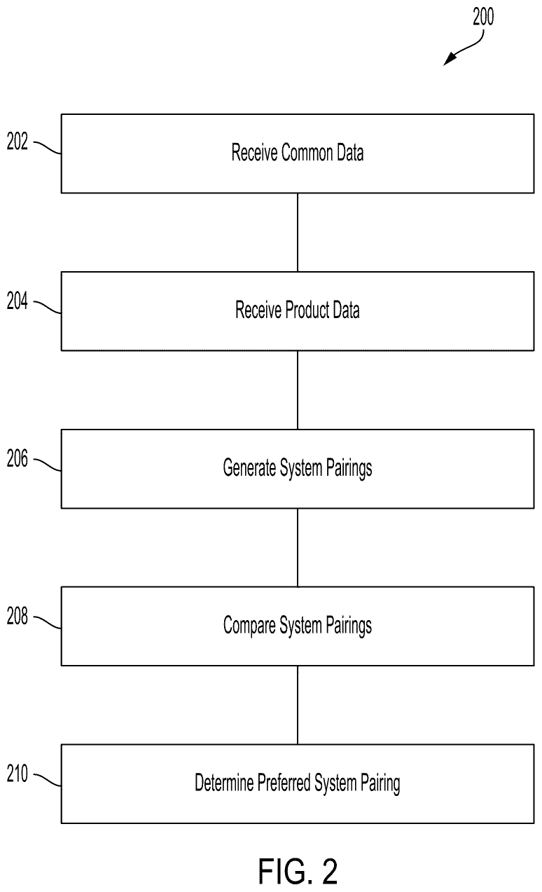

FIG. 2 depicts an example operation of a dynamic fire suppression system configurator. The operation 200 can be performed by one or more system or component depicted in FIG. 1 or FIG. 15, including, for example, a data processing system, sources, or computing devices. At ACT 202, the data processing system can receive common data. The common data can include project details, statuses, system configuration, enclosures, distribution arrangements, actuation groups, system pairings, or other data types. The data can be received from a user via a remote or client device. The data can be associated with a specific project. The data can be a first part of the common data. In response to the first part of the common data, the data processing system can identify and request, based on a business rules engine, a required second part of the common data.

At ACT 204, the data processing system can receive product data. The data processing system can receive the product data from a second source different than the first source. For example, the first source can be a user input and the second source can be a business rules engine. The business rules engine can include a plurality of rules and product data. The product data can be characteristics or specifications for different fire suppression products. The product data received can be based on the common data. For example, the business rules engine can receive the common data, and based on the outcome of the rules in the BRE, provide the product data.

At ACT 206, the data processing system can generate system pairings. The system pairings can be unique pairings of actuation groups and system configurations. Actuation groups can be groups of enclosures for a space of the project. Enclosures can be real or virtual spaces that protection is desired for. System configurations can be selections for one or more fire suppression products. The system configurations can also include installation settings such as a selector valve selection, a manual actuator selection, and other installation related settings. System configurations and actuation data can be a part of the common data. The same actuation group can be paired with different system configurations to generator different system pairings. The same system configuration can be paired with different actuation groups to generate different system pairings.

At ACT 208, the data processing system compares the system pairings. The data processing system can compare one or more parameters of the system pairings. The parameters can be a cost, floor space occupied, estimated installation time, lifespan, capability, or other parameter. At ACT 210, the data processing system determines the target system pairing. The data processing system can determine the target system pairing based on the comparison or based on a user input. The target system pairing is at least one of the plurality of generated system pairings. The target system pairing can be more than one of the plurality of generated system pairings.

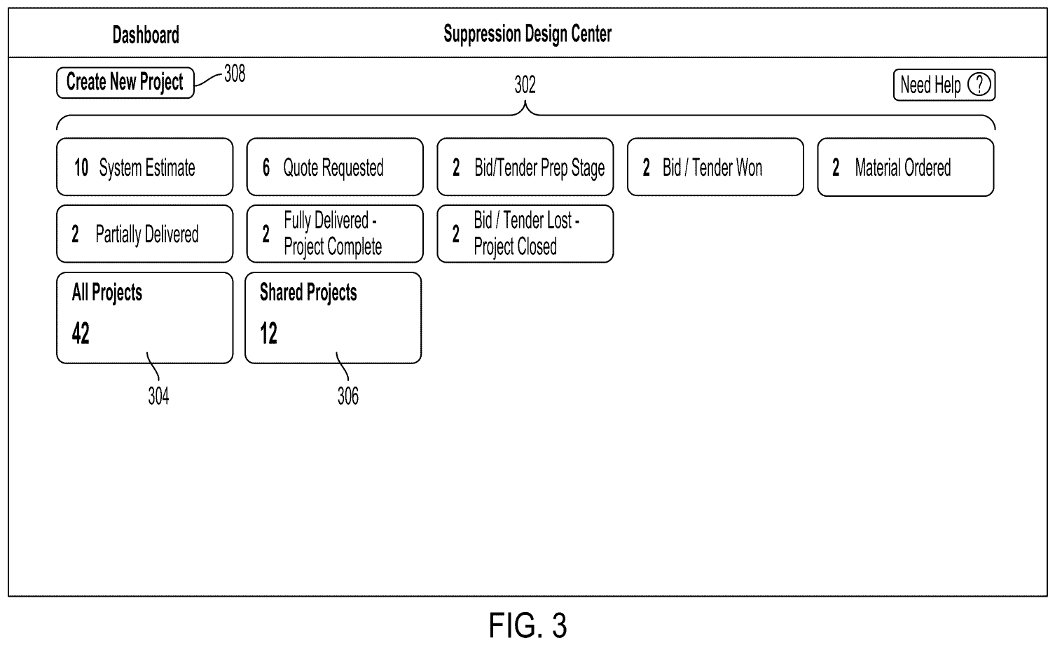

FIG. 3 is an illustration of a graphical user interface for configuring a fire suppression system. The graphical user interface (GUI) 300 can be provided by one or more system or component depicted in FIG. 1 or FIG. 15, including, for example, a data processing system 102. The GUI 300 indicates a status 302, all projects 304 and shared projects 306. The status 302 can include a depiction of a status for each of the projects in a dynamic fire suppression system configurator. For example, the status can be the statuses 118 of the data processing system 102. The all projects 304 can depict a count of the number of projects in the dynamic fire suppression system configurator. The shared projects 306 can depict the number of shared projects in the dynamic fire suppression system configurator. The GUI 300 can include a new projects 308 to create a new project.

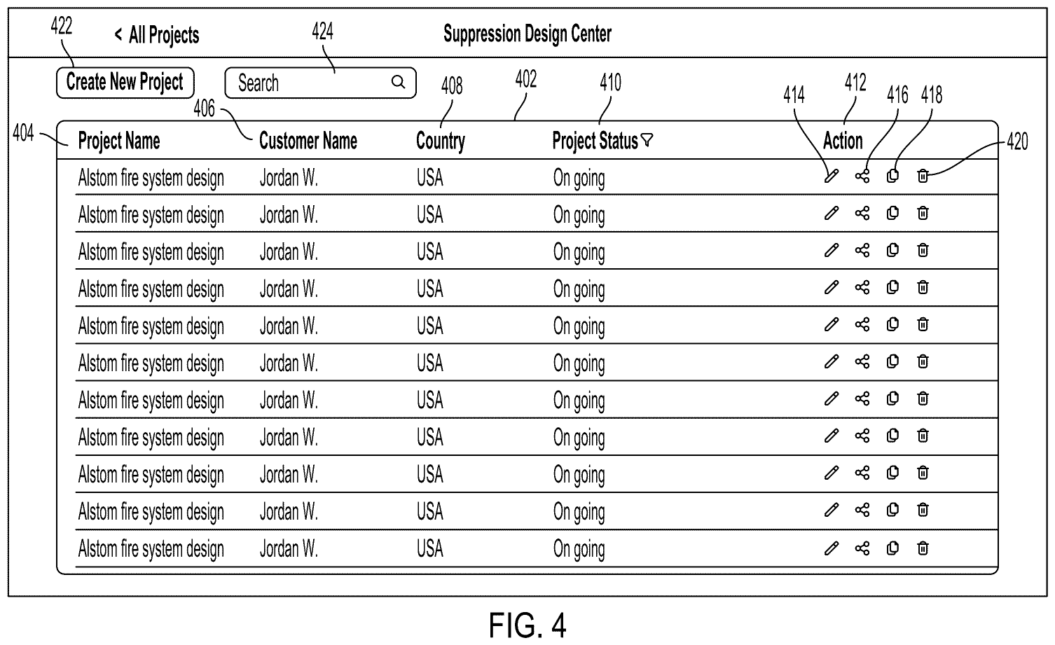

FIG. 4 is an illustration of a graphical user interface for viewing the projects in a dynamic fire suppression system configurator. The graphical user interface (GUI) 400 can be provided by one or more system or component depicted in FIG. 1 or FIG. 15, including, for example, a data processing system 102. The GUI 400 can be displayed in response to a selection of all projects 304 in GUI 300. The GUI 400 can include a table 402 including a list of all projects in the dynamic fire suppression system configuration. For example, the table 402 can list the projects 114 in the data processing system 102. The table 402 can include a project name column 404, a customer name column 406, a country column 408, a project status column 410, and an action column 412. The action column 412 can include action items including an edit action 414, a share action 416, a copy action 418, and a delete action 420. The GUI can include a create new project 422 selection to allow a user to create a new project within the dynamic fire suppression system configurator. The GUI 400 can include a search 424 interface in which a user can enter a search query to identify one or more projects shown in the table 402.

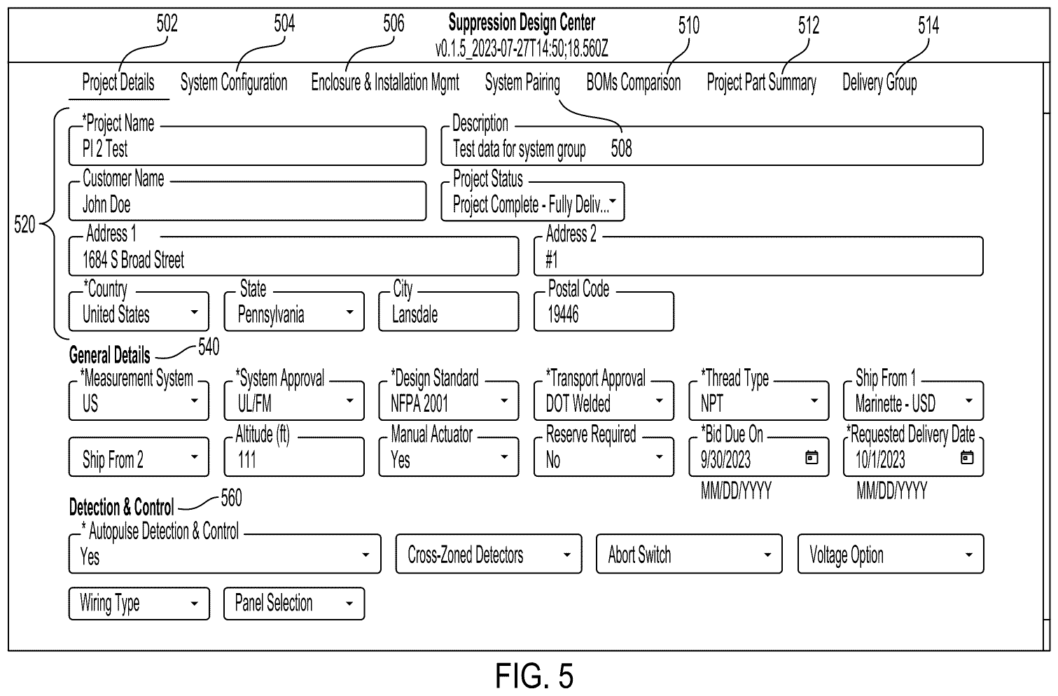

FIG. 5 is an illustration of a graphical user interface for editing projects in a dynamic fire suppression system configurator. The graphical user interface (GUI) 500 can be provided by one or more system or component depicted in FIG. 1 or FIG. 15, including, for example, a data processing system 102. The GUI 500 can be displayed in response to a selection of the create new project 422 or in the case of an existing project, the edit action 414 of GUI 400. The GUI 500 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The project details 502 view can include a preliminary section 520, a general details section 540, and a detection and control section 560. The preliminary section 520 includes project details such as a project name, description, customer name, project status, first and second address for the client, a country, a state, a city, and a postal code for the client. The general details section 540 can include a system of measurement for the project (e.g., Imperial, metric, or another system) a fire suppression system approval authority (e.g., UL, FM, or another approval) a design standard, a transport approval authority, a thread type, one or more ship from locations, an altitude, whether a manual actuator should be present, whether a reserve is required, a bid due date, a requested delivery data, and detection and control settings for the project. The detection and control section 560 can include parameters for a detection and control system of a fire suppression system such as the inclusion of an auto pulse detection and control, cross-zoned detectors, an abort switch, a voltage option, a wiring type, and a panel connection.

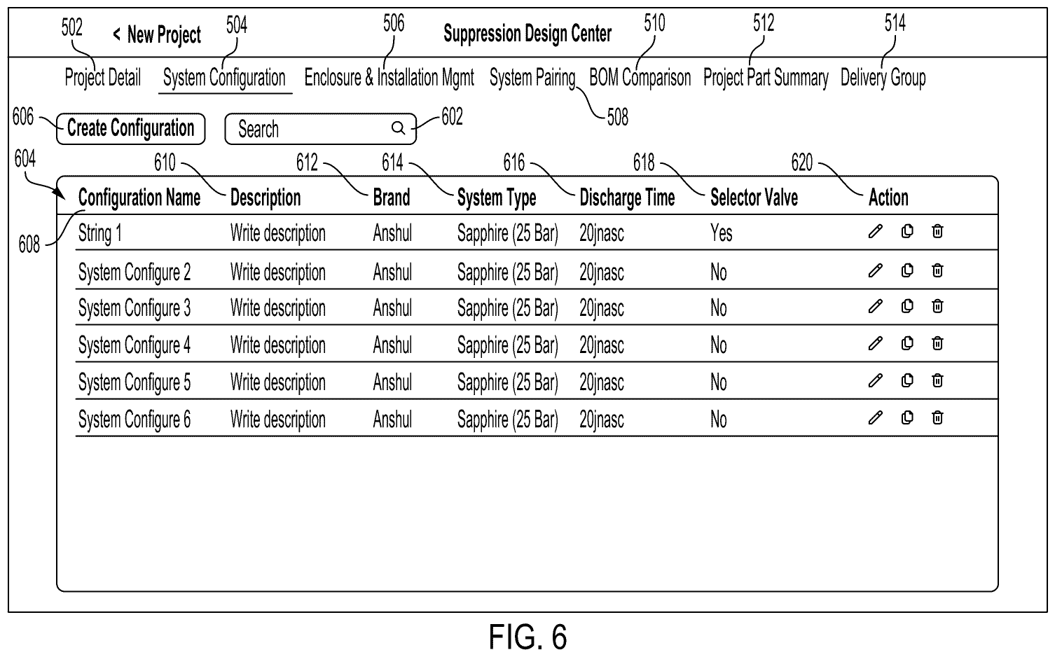

FIG. 6 is an illustration of a graphical user interface for viewing system configurations in a dynamic fire suppression system configurator. The graphical user interface (GUI) 600 can be provided by one or more system or component depicted in FIG. 1 or FIG. 15, including, for example, a data processing system 102. The GUI 600 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 600 can be displayed in response to a selection of the system configuration 504 view of GUI 500. The GUI 600 can include a search 602 interface in which a user can enter a search query for a specific system configuration as shown in the table 604. For example, the table 604 can include system configurations 120 of data processing unit 102. The GUI 600 can include or allow for the selection of a create configuration 606 selection to create a new system configuration for the dynamic fire suppression system configurator. The table 604 can include a configuration name column 608, a description column 610, a brand column 612, a system type column 614, a discharge time column 616, a selector valve column 618, and an action column 620. The brand column 612 can include a designation of the fire suppression system manufacturer for the system configuration. The system configuration can include product details for a specific fire suppression product made by a specific fire suppression manufacture. The system type column 614 can indicate the specific fire suppression product selected. The discharge time column 616 can indicated the discharge time of the selected system type. The selector valve column 618 can indicate if a selector valve for the suppression system is to be included in the system pairing or potential fire suppression system design. The action column can include actions to edit, copy, or delete a system configuration.

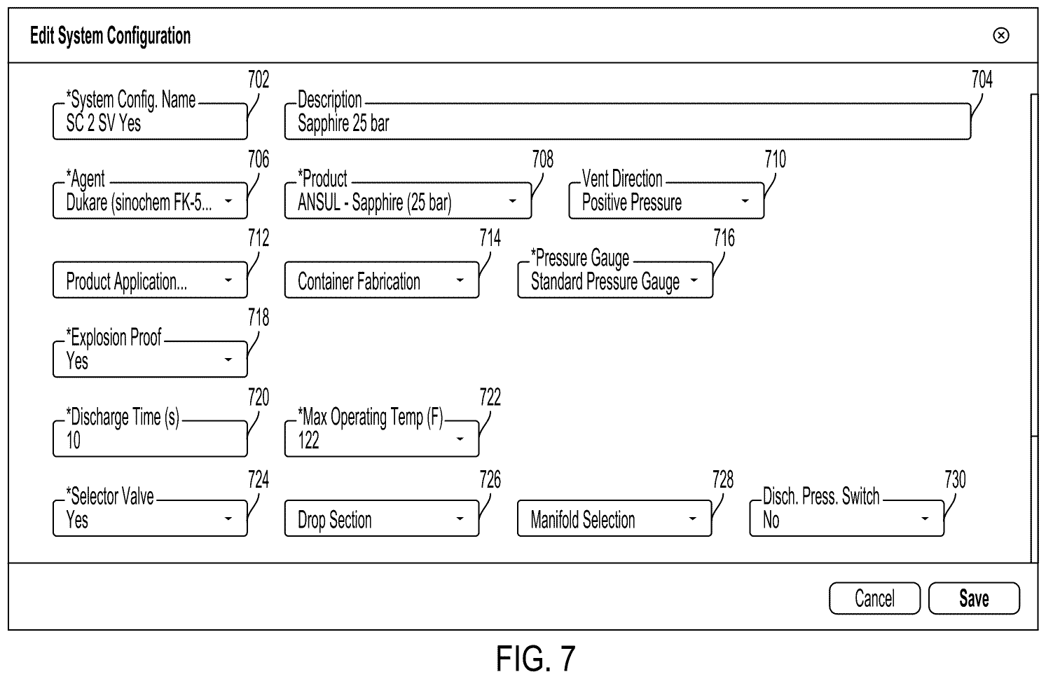

FIG. 7 is an illustration of a graphical user interface for creating or editing a system configuration in a dynamic fire suppression system configurator. The graphical user interface (GUI) 700 can be provided by one or more system or component depicted in FIG. 1 or FIG. 15, including, for example, a data processing system 102. The GUI 700 can be displayed in response to a selection of the system configuration edit a system configuration or create a new system configuration 606 view of GUI 600. The GUI 700 includes fields for a system configuration name 702, a description 704, an agent selection 706, a product selection 708, a vent direction 710, a product application 712, a container fabrication 714, a pressure gauge 716, an explosion proof 718, a discharge time 720, a max operating temperature 722, a selector valve 724, a drop section 726, a manifold selection 728, and a discharge pressure switch 730. The agent selection 706 can include a selection from a list of possible agents. The list of possible agents can be provided by a business rules engine. For example, the list of possible agents can be provided by BRE 134. The product selection 708 includes a selection of a specific fire suppression product. The GUI 700 can display a list of possible fire suppression products based on the agent selection 706.

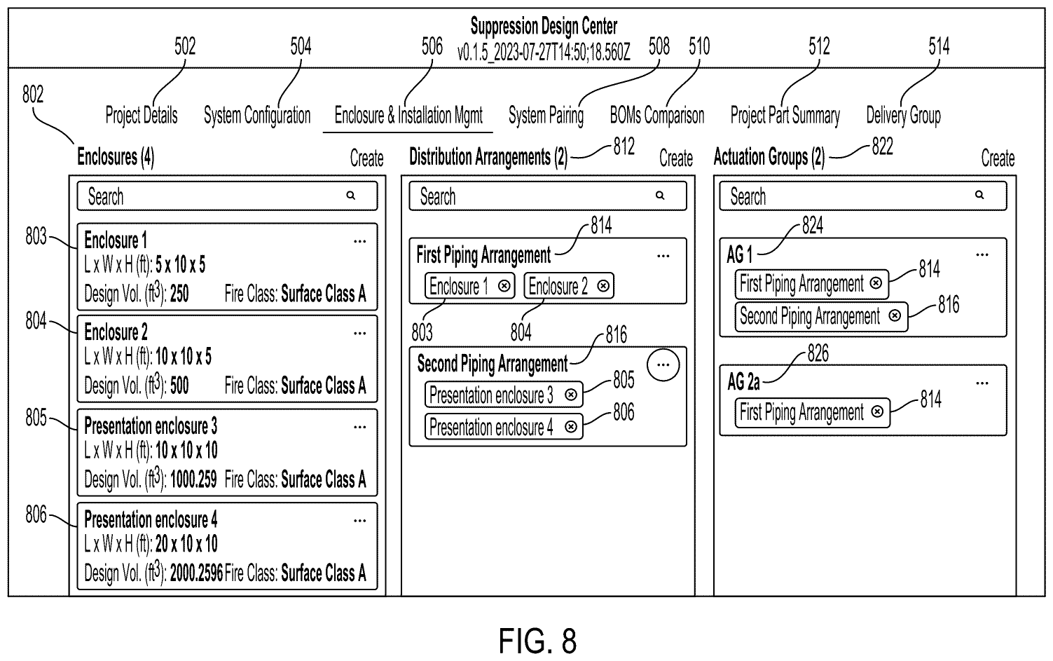

FIG. 8 is an illustration of a graphical user interface for providing space information in a dynamic fire suppression system configurator. The graphical user interface (GUI) 800 can be provided by one or more system or component depicted in FIG. 1 or FIG. 15, including, for example, a data processing system 102. The GUI 800 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 800 can be displayed in response to a selection of the enclosure & installation management 506 view of GUI 500. The GUI 800 can include an enclosure section 802, a distribution piping arrangement section 812, and a actuation grouping section 822. The enclosure section 802 depicts a first enclosure 803, a second enclosure 804, a third enclosure 805, a fourth enclosure 806. The plurality of enclosures 803-806 can correspond to the enclosures 122 of the data processing system 102. Each of the plurality of enclosures 803-806 can include enclosure information such as enclosure dimensions, enclosure floor area and longest side, enclosure design volume, or enclosure fire class.

The distribution arrangement section 812 includes a first distribution arrangement 814, and a second distribution arrangement 816. The distribution arrangements 814 and 816 can correspond to the distribution arrangements 124 in the data processing system 102. Each of the distribution arrangements 814 and 816 includes one or more enclosures. For example, the first distribution arrangement 814 includes the first enclosure 803 and the second enclosure 804. The second distribution arrangement 816 includes the third enclosure 805 and the fourth enclosure 806. Each distribution arrangement includes a unique subset of the plurality of enclosures in the enclosures 802 section.

The actuation grouping section 822 includes a first actuation grouping 824 and a second actuation grouping 828. Each of the actuation groupings 824, 828, can include one or more distribution arrangements, including the same distribution piping arrangement. The first actuation grouping 824 includes the first distribution arrangement 814 and the second distribution arrangement 816. The second distribution grouping includes the first distribution arrangement 814

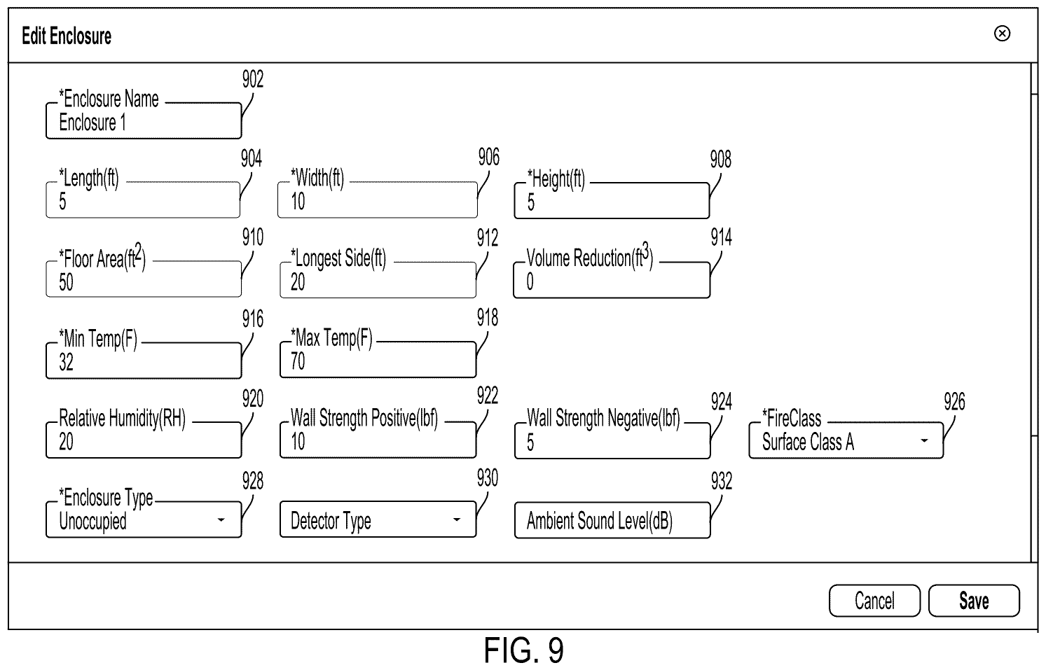

FIG. 9 is an illustration of a graphical user interface for providing enclosure information in a dynamic fire suppression system configurator. The graphical user interface (GUI) 900 can be provided by one or more system or component depicted in FIG. 1 or FIG. 15, including, for example, a data processing system 102. The GUI 900 can be displayed in response to a selection of the edit an enclosure 803-806 of GUI 800. The GUI 900 allows a user to modify the characteristics of an enclosure including an enclosure name 902 and dimension values such as a length 904, a width 906, a height 908, a floor area 910, a longest side 912, or a volume 914. The GUI 900 can also include fields for a minimum temperature 916, a maximum temperature 918, a relative humidity 920, a wall strength (positive 922 and negative 924), a fire class 926, an enclosure type 928, a detector type 930, and an ambient sound level 932.

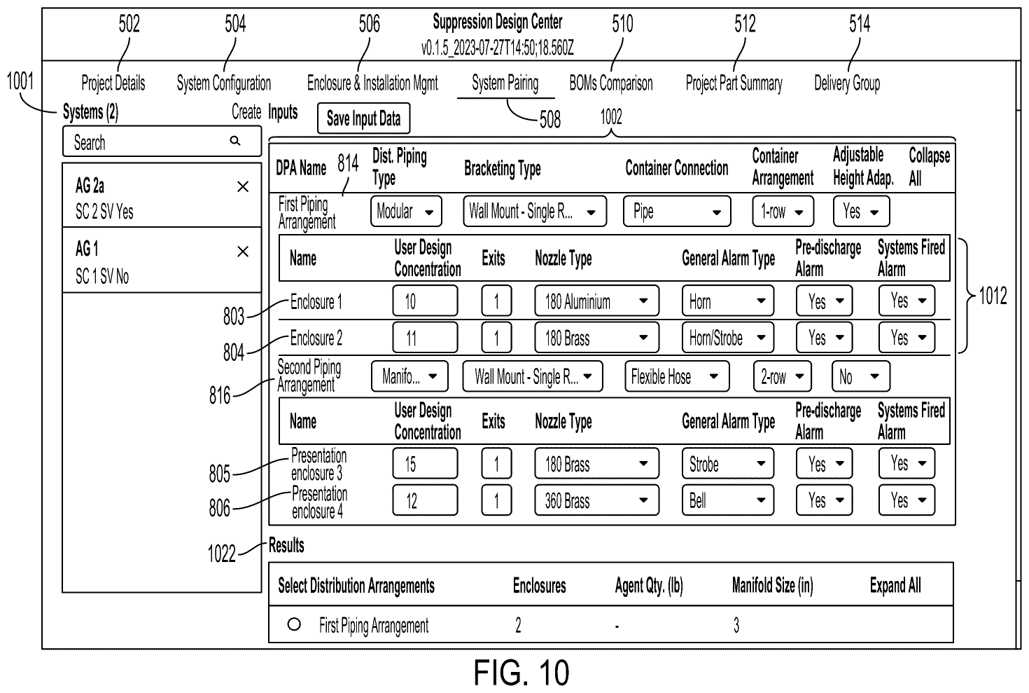

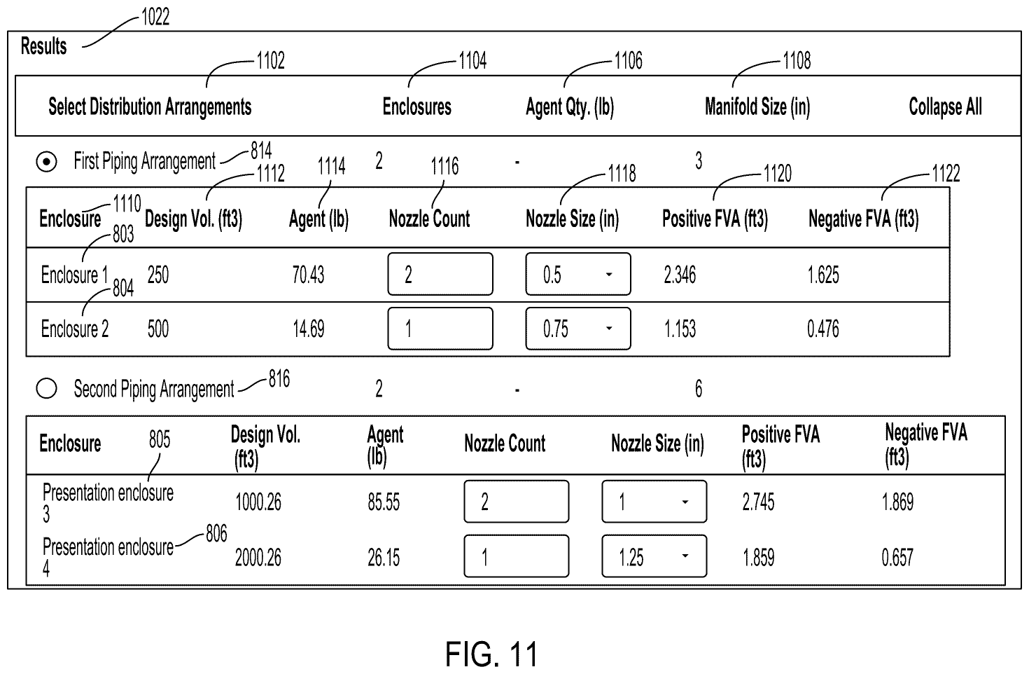

FIG. 10 is an illustration of a graphical user interface for providing system pairing information in a dynamic fire suppression system configurator. The graphical user interface (GUI) 1000 can be provided by one or more system or component depicted in FIG. 1 or FIG. 15, including, for example, a data processing system 102. The GUI 1000 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 1000 can be displayed in response to a selection of the system pairing 508 view of GUI 500. The GUI 1000 includes a view of the one or more system pairings for a dynamic fire suppression system configurator. GUI 1000 includes a system pairing list 1001 and a first piping arrangement selection 1002 including distribution piping type, bracketing types, container arrangements, and adjustable height adapters. Below the first piping arrangement section is an enclosure section 1012 listing the enclosures in the selected distribution arrangement and various selectable parameters including user design concentrations, exits, nozzle types, general alarm types, pre-discharge alarm selections, and system fired alarm selections. The same repeats for each distribution arrangement in the actuation group. Beneath the enclosure 1012 is a results section 1022. FIG. 11 is an illustration of the results section 1022 of GUI 1000. The results section 1022 includes selections for each of the distribution arrangements and a summary of the various parameters previously, selected, input, or provided by the BRE.

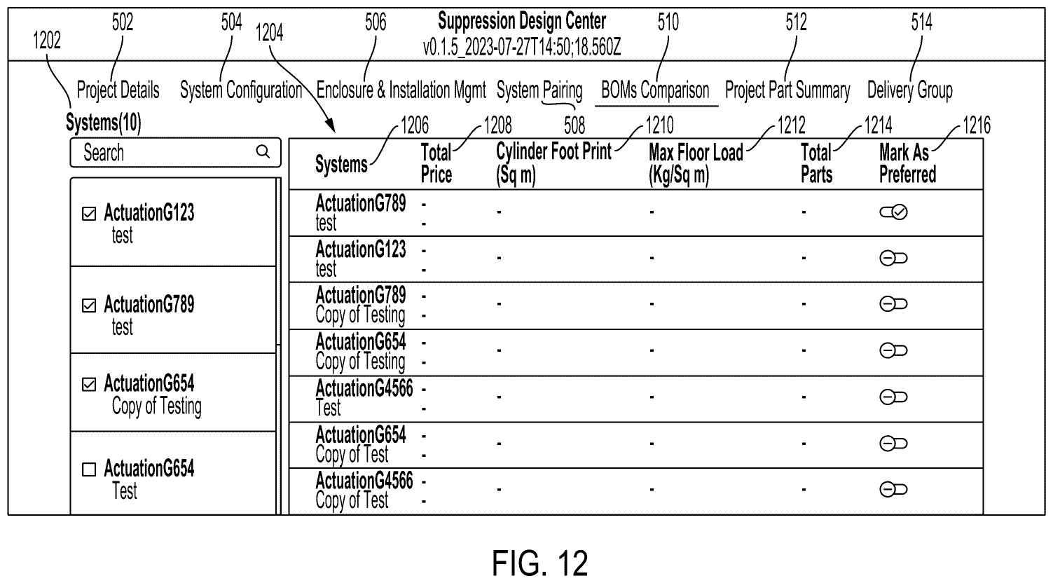

FIG. 12 is an illustration of a graphical user interface for comparing system pairings in a dynamic fire suppression system configurator. The graphical user interface (GUI) 1200 can be provided by one or more system or component depicted in FIG. 1 or FIG. 15, including, for example, a data processing system 102. The GUI 1200 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 1200 can be displayed in response to a selection of the BOMs Comparison 510 view of GUI 500. The GUI 1200 includes a list of system pairings 1202. Each system pairing includes a check box for selecting the system pairings for review. The GUI 1200 includes a table 1204 for displaying the selected system pairings from the list 102. The table 1204 includes a systems column 1206, a total price column 1208, a cylinder foot print column 1210, a max floor load column 1212, a total parts column 1214, and a mark as target column 1216. The columns of table 1204 represent various parameters for each system pairing that can be compared to determine a target system pairing as indicated in column 1216. Other parameters may also be included. A user may mark one or more system pairings in the table as a target system pairing. The dynamic fire suppression system configurator can also select a target system pairing based on predefined or user-defined criteria or rules.

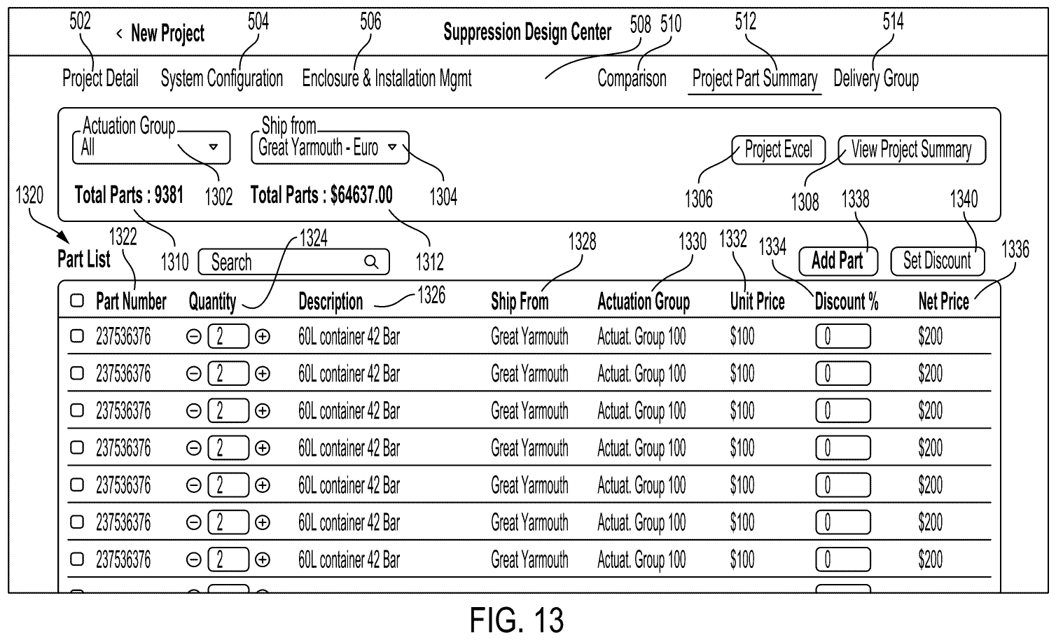

FIG. 13 is an illustration of a graphical user interface for comparing system pairings in a dynamic fire suppression system configurator. The graphical user interface (GUI) 1300 can be provided by one or more system or component depicted in FIG. 1 or FIG. 15, including, for example, a data processing system 102. The GUI 1300 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 1300 can be displayed in response to a selection of the Project Part Summary 512 view of GUI 500. The GUI 1300 includes a actuation group filter 1302 and a ship from filter 1034 to filter the total parts count 1310 and the total price count 1312. The GUI 1300 includes an export to excel 1306 and a view project summary 1308. The GUI 1300 can depicts a table 1320 listing the individual parts for the selected system pairings. The table 1320 can correspond to a bill of materials 130 of the data processing system 102. The table 1320 includes a part number column 1322, a quantity column 1324, a description column 1326, a ship from column 1328, an actuation group column 1330, a unit price column 1332, a discount column 1334, and a net price column 13336. The GUI 1300 includes an add part selection 1338 and a set discount selection 1390 to fill the discount column 1334 en masse.

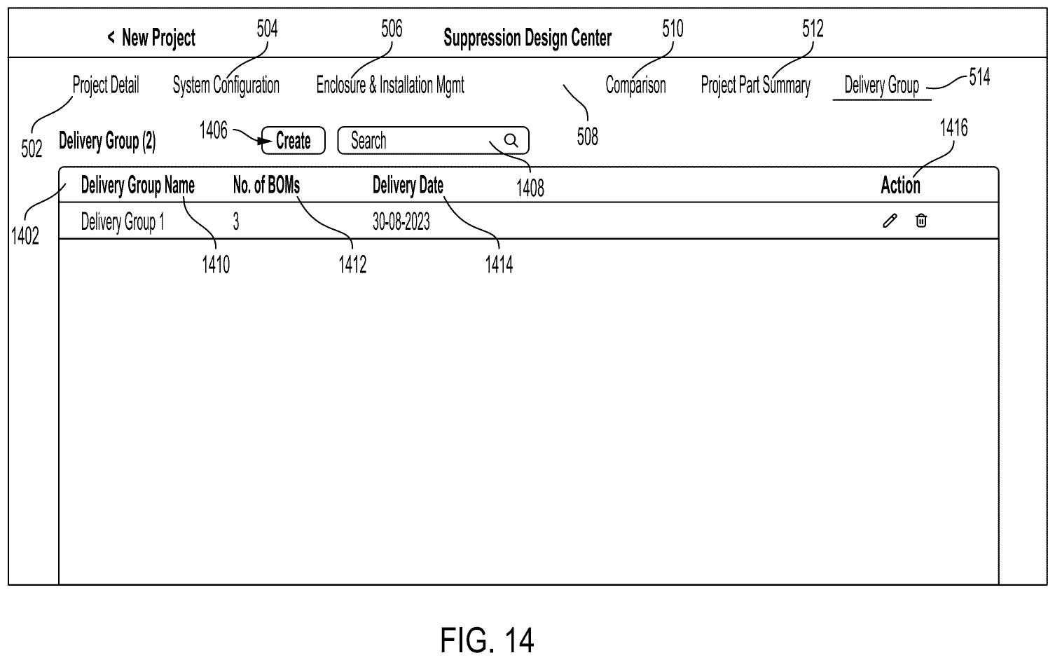

FIG. 14 is an illustration of a graphical user interface for comparing system pairings in a dynamic fire suppression system configurator. The graphical user interface (GUI) 1400 can be provided by one or more system or component depicted in FIG. 1 or FIG. 15, including, for example, a data processing system 102. The GUI 1400 can include or provide various views, including for example, a project details 502 view, a system configuration 504 view, an enclosure & installation management 506 view, a system pairing 508 view, a BOMs Comparison 510 view, a Project Part Summary 512 view, and a Delivery Group 514 view. The GUI 1300 can be displayed in response to a selection of the Delivery Group 514 view of GUI 500. The GUI 1400 includes a delivery group table 1402 indicating the current delivery groups. A delivery group is a group of one or more system pairings as identified by a BOM to be deliver. The GUI 1400 includes a create selection 1406 and a search selection 1408. The table 1402 includes a delivery group name column 1410, a number of BOMs column 1412, a delivery date column 1414, and an action column 1416 to edit or delete delivery groups.

Referring to FIGS. 3-14, it should be understood that some fields are mandatory and some fields are optional. Moreover, though FIGS. 3-14 present GUIs 300-1400 in a certain order, the order of GUIs 300-1400 can change depending on a user's selection within the GUI. The GUIs 300-1400 can be dynamically modified by a business rules engine based on inputs to or selections within the GUIs. While the GUIs 300-1240 are shown to include various parameters and fields, other or different parameters and fields can be included based on at least one of the rules or product data of the BRE or the common data provided to the BRE.

FIG. 15 depicts an example block diagram of an example computer system 1500. The computer system or computing device 1500 can include or be used to implement a data processing system or its components. The computing system 1500 includes at least one bus 1505 or other communication component for communicating information and at least one processor 1510 or processing circuit coupled to the bus 1505 for processing information. The computing system 1500 can also include one or more processors 1510 or processing circuits coupled to the bus for processing information. The computing system 1500 also includes at least one main memory 1515, such as a random access memory (RAM) or other dynamic storage device, coupled to the bus 1505 for storing information, and instructions to be executed by the processor 1510. The main memory 1515 can be used for storing information during execution of instructions by the processor 1510. The computing system 1500 may further include at least one read only memory (ROM) 1520 or other static storage device coupled to the bus 1505 for storing static information and instructions for the processor 1510. A storage device 1525, such as a solid state device, magnetic disk or optical disk, can be coupled to the bus 1505 to persistently store information and instructions.

The computing system 1500 may be coupled via the bus 1505 to a display 1535, such as a liquid crystal display, or active matrix display, for displaying information to a user such as a driver of the electric vehicle 1505 or other end user. An input device 1530, such as a keyboard or voice interface may be coupled to the bus 1505 for communicating information and commands to the processor 1510. The input device 1530 can include a touch screen display 1535. The input device 1530 can also include a cursor control, such as a mouse, a trackball, or cursor direction keys, for communicating direction information and command selections to the processor 1510 and for controlling cursor movement on the display 1535.

The processes, systems and methods described herein can be implemented by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. Hard-wired circuitry can be used in place of or in combination with software instructions together with the systems and methods described herein. Systems and methods described herein are not limited to any specific combination of hardware circuitry and software.

Although an example computing system has been described in FIG. 15, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system of fire suppression system configuration, comprising:
one or more processors to:
receive, from a first source, common data for a project;
receive, from a second source different than the first source, product data comprising product specifications for a plurality of fire suppression products; and
generate, based on the common data and the product data, a plurality of system pairings for the project, each system pairing comprising a list of fire suppression components for the project.

2. The system of claim 1, comprising:
the product data comprises first product data; and
the one or more processors are to:
detect, from the common data, at least one of a location of the project or a performance criterion for the project;
identify, according to the at least one of the location or the performance criterion, a mapping between the at least one of the location or the performance criterion and the first product data and not between the at least one of the location or the performance criterion and second product data; and
generate the plurality of system pairings based on the mapping.

3. The system of claim 1, comprising:
the common data comprising a plurality of enclosures, each enclosure of the plurality of enclosures defining a space within the project, a plurality of distribution arrangements, each distribution arrangement of the plurality of distribution arrangements comprising a subset of the plurality of enclosures, and a plurality of actuation groups, each actuation group comprising a subset of the plurality of distribution arrangements;
each system pairing based on an actuation group and a system configuration, the plurality of system pairings including system pairings of different system configurations for the same actuation group.

4. The system of claim 1, comprising:
the one or more processors are to determine, based on a comparison of at least one parameter of each of the plurality of system pairings, a target system pairing of the plurality of system pairings; and
provide an indication of the target system pairing.

5. The system of claim 1, comprising:
the one or more processors are to provide an indication of a selected system pairing of the plurality of system pairings to a supplier entity.

6. The system of claim 1, comprising:
the one or more processors are to generate a confidence value based on at least one of the common data or the product data.

7. The system of claim 1, comprising:
the one or more processors are to provide a selection of a target system pairing of the plurality of system pairings according to a confidence value associated with the selection and based on at least one of the common data or the product data.

8. The system of claim 1, comprising:
the second source comprises a plurality of rules; and
the one or more processors are to:
receive a first part of the common data;
determine, based on the plurality of rules, a second part of the common data;
retrieve, from the first source, the second part of the common data.

9. The system of claim 1, comprising:
the second source comprising a rules engine.

10. The system of claim 1, comprising:
the product data based on the common data.

11. A method of configuring a fire suppression system, comprising:
receiving, by one or more processors, common data for a project from a first source;
receiving, by the one or more processors, product data comprising product specifications for a plurality of fire suppression products from a second source different than the first source;
generating, based on the common data and the product data, a plurality of system pairings for the project, each system pairing comprising a list of fire suppression components for the project based on the common data and a unique system configuration.

12. The method of claim 11, comprising:
the common data comprising a plurality of enclosures, each enclosure of the plurality of enclosures defining a space within the project, a plurality of distribution arrangements, each distribution arrangement of the plurality of distribution arrangements comprising a subset of the plurality of enclosures, and a plurality of actuation groups, each actuation group comprising a subset of the plurality of distribution arrangements;
each system pairing based on an actuation group and a system configuration, the plurality of system pairings including system pairings of different system configurations for the same actuation group.

13. The method of claim 11, comprising:
determining, by the one or more processors, based on a comparison of at least one parameter of each of the plurality of system pairings, a target system pairing of the plurality of system pairings; and
providing, by the one or more processors, an indication of the target system pairing.

14. The method of claim 11, comprising:
providing, by the one or more processors, an indication to a supplier of at least one fire suppression component contained in a list of fire suppression components of a target system pairing of the plurality of system pairings.

15. The method of claim 11, comprising:
assigning, by the one or more processors, a confidence value to a selected system pairing of the plurality of pairings based on at least one of the common data or the product data; and
provide an indication to a supplier of at least one fire suppression component contained in the list of fire suppression components of the target system responsive to the confidence value being above a threshold.

16. The method of claim 11, comprising:
the second source comprising a plurality of rules to generate a system pairing by based on the common data;
the method further comprising:
receiving, by the one or more processors, a first part of the common data;
determining, by the one or more processors, based on the plurality of rules a required second part of the common data; and
receiving, from the first source, the required second part of the common data.

17. The method of claim 11, comprising:
the second source comprising a business rules engine.

18. The method of claim 11, comprising:
updating, by the one or more processors, the product data based on the common data.

19. A system to configure a fire suppression system, comprising:
a data processing system comprising one or more processors, coupled with memory, to:
generate a first graphical interface to receive a first part of a common data from a first source;
receive, from a rules engine, a request for a second part of the common data;
generate, based on the request, a second graphical interface to receive the second part of the common data;
receive, from the rules engine, product data comprising system configurations for a plurality of fire suppression products; and
generate, based on the common data and the product data, a plurality of system pairings for the project, each system pairing comprising a list of fire suppression components based on the common data and a unique system configuration.

20. The system of claim 19, comprising:
the data processing system to determine, based on a comparison of at least one parameter of each of the plurality of system pairings, a target system pairing of the plurality of system pairings; and
provide an indication of the target system pairing.
